(19) United States
(12) Patent Application Publication
(10) Pub. No.: US 2007/0020561 A1
(43) Pub. Date: Jan. 25, 2007

(54) Manufacturing method and manufacturing apparatus for an optical data recording medium, and an optical data recording medium

(76) Inventors: Kazuya Hisada, Torrance, CA (US); Keiji Nishikiori, Kyoto (JP)

Correspondence Address: WENDEROTH, LIND & PONACK L.L.P., 2033 K. STREET, NW, SUITE 800, WASHINGTON, DC, 20006, US

(21) Appl. No.: 11/485,491

(22) Filed: Jul. 13, 2006

(30) Foreign Application Priority Data
Jul. 21, 2005 (JP) 2005-210950

(51) Int. Cl. G11B 7/24

(52) U.S. Cl. 430/270.11

(57) ABSTRACT

A manufacturing method for an optical data recording medium having a substrate with at least one signal recording layer and a resin layer for passing light, the manufacturing method includes: coating a radiation-curable resin on the substrate; and forming the resin layer by curing at least a part of the radiation-curable resin by increasing the rotational speed of the substrate to a first speed, then decreasing the rotational speed of the substrate, and emitting radiation while the rotational speed of the substrate is decreasing.

### BACKGROUND OF THE INVENTION

1. Field of the Invention

The present invention relates generally to an optical data recording medium manufacturing method and manufacturing apparatus, and to the optical data recording medium, and relates more particularly to a manufacturing method for a high density optical data recording medium having a thin protective layer, light transmitting layer, and intermediate layer made from radiation-curable resin.

2. Description of Related Art

Optical data recording technology has been the focus of significant research in the data storage industry in recent years. Optical data recording has found applications in a wide range of fields due to a high data density, contactless reading and writing, and low cost. Current optical media include Compact Discs (CD) having a data layer on a 1.2 mm thick transparent resin substrate protected by an overcoat, and Digital Versatile Discs (DVD) having two 0.6 mm thick transparent resin substrates each having a data layer on one or both sides bonded together.

Methods such as increasing the numeric aperture (NA) of the objective lens and shortening the wavelength of the laser used to read and write data have been studied as ways of increasing the optical disc recording density. The thinner the thickness of the read/write substrate (the substrate to which the laser beam is incident), the smaller the effect of aberrations on the laser spot and the greater the tolerance for disc tilt. The Blu-Ray disc media taught in Japanese Patent Laid-open Publication No. H08-235638 therefore sets the thickness of the read/write substrate to approximately 0.1 mm and uses a 0.85 NA and a laser beam with a 400 nm wavelength. However, because of the effect on focusing the read/write beam and spherical aberration, deviation in the thickness of the read/write substrate is preferably 5% or less. For compatibility with existing media and drive devices, the thickness of such discs having a 0.1 mm read/write substrate thickness is preferably 1.2 mm, which is the same as CD and DVD media.

The read/write substrate thickness of such Blu-Ray disc media is only approximately 0.1 mm, and cannot be manufactured using the same injection molding methods used with conventional optical disc media. Manufacturing substrates that are 12 cm in diameter with a thickness less than 0.3 mm is extremely difficult with injection molding. The thickness of the read/write substrate must also be extremely precise. The main method of manufacturing such media is therefore to stamp discs from sheets manufactured using a casting technique, and then bond these stamped discs together. The material cost of such sheets is extremely high, however, and the resulting optical discs are therefore expensive.

Japanese Patent Laid-open Publication No. H10-289489 therefore teaches a method of forming the read/write substrate by using a spin coating method, for example, to apply a radiation-curable resin coat, and then curing the resin.

However, because the read/write substrate requires extremely high thickness precision, advanced spin coating technology is also needed. More particularly, when a liquid UV resin is coated and rotation of the substrate is stopped after coating, surface tension results in a build up of UV resin at the outside perimeter of the round disc. To resolve this problem, International Patent Publication No. WO 2002/101737 teaches curing the UV resin by UV radiation while accelerating disc rotation.

Japanese Patent No. 2924255 and Japanese Patent Laid-open Publication No. H10-199056 also teaches curing the UV resin while shielding the outside perimeter part of the disc in order to maintain the appearance of the outside edge area of the optical disc.

The foregoing methods cannot, however, achieve the high thickness precision that is required in the read/write substrate while also maintaining the appearance at the outside edge part of the optical disc, and manufacturing optical discs consistently in a mass production environment is difficult.

For example, when the substrate is coated with resin and the coated substrate is then spun at a constant speed while exposed to UV radiation, the resin thickness at the outside edge part becomes extremely thin or is cured with resin overhanging from the outside edge of the substrate.

Uniform thickness precision can be achieved by exposing the resin to UV radiation while accelerating disc rotation, but if the UV radiation is emitted before the excess resin is completely spun off the outside edge part of the substrate, the resin will be cured before the excess is removed and a rough edge will be left around the perimeter of the disc. Furthermore, if the disc is accelerated too greatly, both excess resin and resin slightly to the inside of the outside edge part (that is, near the outside edge part) will be spun off, and the thickness of the resin coating near the outside edge part of the substrate will become too thin.

### SUMMARY OF THE INVENTION

An object of the present invention is therefore to provide a manufacturing method and a manufacturing apparatus for an optical data recording medium whereby thickness variations in radiation-cured resin built up by surface tension near the outside edge part of the substrate can be suppressed and roughness at the outside edge of the substrate can be suppressed when a radiation-curable resin is coated on a substrate when manufacturing an optical data recording medium having a protective layer, an intermediate layer, and a light transmitting layer made of radiation-curable resin.

To achieve this object, a manufacturing method according to a first aspect of the invention for an optical data recording medium having a substrate with at least one signal recording layer and a resin layer for passing light has the steps of: coating a radiation-curable resin on the substrate; and forming the resin layer by curing at least a part of the radiation-curable resin by increasing the rotational speed of the substrate to a first speed, then decreasing the rotational speed of the substrate, and emitting radiation while the rotational speed of the substrate is decreasing.

This optical data recording medium manufacturing method enables manufacturing an optical data recording medium having a light transmitting layer and intermediate layer made from a radiation-curable resin to an extremely uniform and stable thickness to near the outside edge part of the substrate.

Preferably, the step of forming the resin layer forms the resin layer by curing at least a part of the radiation-curable resin by emitting radiation after the rotational speed of substrate reaches a second speed that is lower than the first speed.

Further preferably, the step of forming the resin layer forms the resin layer by curing at least a part of the radiation-curable resin by emitting radiation while rotating the substrate at the second speed for a predetermined time.

Yet further preferably, the step of forming the resin layer forms the resin layer by curing at least a part of the radiation-curable resin by emitting radiation to the substrate through a light shielding mask, the light shielding mask having a round hole with an inside diameter equal to or less than the outside diameter of the substrate, and disposed with this hole in the light shielding mask concentric to the substrate.

Yet further preferably, this manufacturing method also has a step of spinning off uncured resin at the outside edge part of the substrate after the step of forming the resin layer by accelerating the rotational speed of the substrate to a predetermined speed that is higher than the first speed.

Yet further preferably, this manufacturing method also has a step of emitting radiation to the outside edge part of the substrate to cure the radiation-curable resin at the outside edge part of the substrate after the step of spinning off uncured resin at the outside edge part of the substrate.

The step of coating the radiation-curable resin can use a spin coating method.

The step of coating the radiation-curable resin can also use a substrate with a center hole, and cover the center hole to coat the radiation-curable resin on the substrate.

The resin layer may be a light transmitting layer rendered on top of a signal recording layer. The resin layer may also be a protective layer. Further alternatively, the resin layer may be an intermediate layer rendered between a plurality of signal recording layers.

In another aspect of the invention there is an additional step of forming an intermediate layer by applying a stamper having a pattern of grooves or pits and lands to the at least partly cured resin on the substrate, and then emitting radiation to cure the uncured resin after the step of forming the resin layer.

A manufacturing apparatus for an optical data recording medium according to another aspect of the invention includes: a rotating table operable to rotatably hold a substrate coated with a radiation-curable resin; a motor operable to rotate the rotating table; a radiation lamp operable to emit radiation to the radiation-curable resin on the substrate to cure at least a part of the radiation-curable resin; and a control unit operable to control the speed of the motor and the emission timing of the radiation lamp.

In another aspect of the invention, the optical data recording medium manufacturing apparatus further includes a light shielding mask having a round hole with an inside diameter equal to or less than the outside diameter of the substrate, the light shielding mask disposed between the substrate and the radiation lamp without contacting the substrate and with the hole in the light shielding mask concentric to the substrate as seen from the radiation lamp. Radiation is emitted from the radiation lamp through the light shielding mask to the substrate.

In the optical data recording medium manufacturing apparatus according to another aspect of the invention, the control unit increases the speed of the motor to a first speed, then decreases the speed, and emits radiation from the radiation lamp to the radiation-curable resin on the substrate while the rotational speed of the substrate is decreasing.

In the optical data recording medium manufacturing apparatus according to another aspect of the invention, the control unit increases the speed of the motor to a first speed, then decreases the speed, and after the motor reaches a second speed that is lower than the first speed emits radiation from the radiation lamp.

An optical data recording medium according to the present invention is an optical data recording medium manufactured by a manufacturing method of the invention where the resin layer thickness near the outside edge part of the substrate is 10 μm or more thinner than the average thickness of the entire resin layer on the substrate.

The optical data recording medium manufacturing method of the present invention can manufacture optical data recording media having high thickness precision, no burrs on the outside edge of the substrate, and an excellent appearance when using a radiation-curable resin or other fluid material to form the light transmitting layer.

Other objects and attainments together with a fuller understanding of the invention will become apparent and appreciated by referring to the following description and claims taken in conjunction with the accompanying drawings.

### BRIEF DESCRIPTION OF THE DRAWINGS

The present invention will become readily understood from the following description of preferred embodiments thereof made with reference to the accompanying drawings, in which like parts are designated by like reference numeral and in which:

FIG. 1 is a block diagram showing the arrangement of an optical data recording medium manufacturing apparatus according to a first embodiment of the invention;

FIG. 2A is a plan view showing the relative positions of the light shielding mask and the substrate, and FIG. 2B is a section view of FIG. 2A;

FIGS. 3A and 3B are section views showing the position of different types of light shielding mask to the substrate,

FIG. 4 is a flow chart of the manufacturing method according to a first embodiment of the invention;

FIG. 5 is a timing chart showing the relationship between time and rotational speed of the substrate in the manufacturing method of the first embodiment of the invention;

FIGS. 6A to 6C are section views describing the radiation-curable resin coating process of step S01 shown in FIG. 4;

FIG. 7 is a detailed flow chart of the process executed as the step S02 in FIG. 4 of curing the radiation-curable resin by emitting radiation while the rotational speed of the substrate is decelerating;

FIG. 8 is a detailed flow chart of the process executed as the step S03 in FIG. 4 of spinning off excess resin;

FIG. 9A is a section view showing the state of the uncured resin near the outside edge part of the optical data recording medium before the step of spinning off excess resin in the optical data recording medium manufacturing method according to a first embodiment of the invention, and FIG. 9B is a section view showing the condition of the uncured resin near the outside edge part of the optical data recording medium after the excess resin spinning off step;

FIG. 10 is a flow chart showing another example of step S02 in the optical data recording medium manufacturing method according to a first embodiment of the invention;

FIGS. 11A to 11C are section views showing the distribution of radiation-curable resin near the outside edge part of the optical data recording medium in the first embodiment of the invention;

FIGS. 12A and 12B are timing charts describing radiation emission at different rates of rotational speed of the substrate acceleration and deceleration,

FIG. 13 is a section view of an optical data recording medium having a protective layer according to a second embodiment of the invention;

FIG. 14A is a section view showing an example of a two-layer optical data recording medium and FIG. 14B is a section view showing an example of a four-layer optical data recording medium in a third embodiment of the invention; and

FIGS. 15A and 15B are section views describing the intermediate layer formation steps in an optical data recording medium manufacturing method according to a third embodiment of the invention.

### DESCRIPTION OF THE PREFERRED EMBODIMENTS

An optical data recording medium manufacturing method and manufacturing apparatus according to preferred embodiments of the present invention are described below with reference to the accompanying figures wherein like parts are identified by the same reference numerals. In addition, only one side of parts that are symmetrical to a common axis may be shown in the figures with the other side omitted for brevity.

First Embodiment

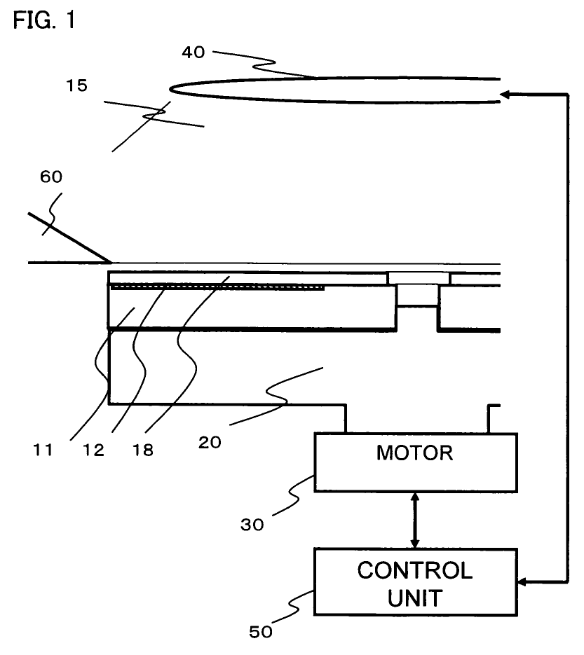

An optical data recording medium manufacturing method and manufacturing apparatus according to a first embodiment of the invention are described below. FIG. 1 is a block diagram of an optical data recording medium manufacturing apparatus according to a first embodiment of the invention.

The optical data recording medium manufacturing apparatus according to this embodiment of the invention includes a rotating table 20 for rotatably holding a substrate 11 coated with a radiation-curable resin 18, a motor 30 for rotating the rotating table 20, a radiation lamp 40 for emitting radiation 15 to the radiation-curable resin 18 on the substrate 11 to cure at least a part of the radiation-curable resin 18, and a control unit 50 for controlling the speed of the motor 30 and the emission timing of the radiation lamp 40. This manufacturing apparatus may also have a light shielding mask 60 disposed between the substrate 11 and motor 30 without contacting the substrate 11.

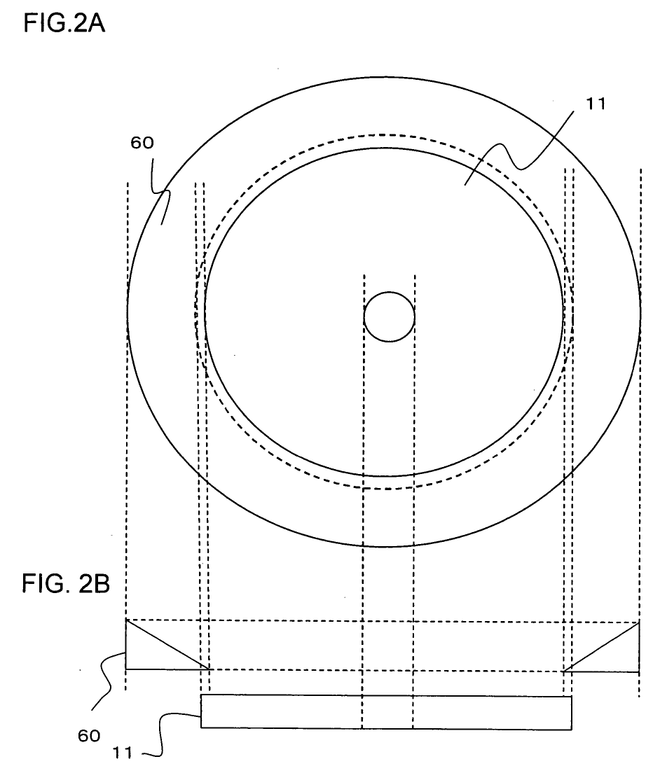

As shown in FIG. 2A, this light shielding mask 60 has a round hole with an inside diameter that is equal to or smaller than the outside diameter of the substrate 11, and is positioned so that this hole is concentric to the substrate 11 as seen from the radiation lamp 40 side. Radiation 15 is therefore emitted from the radiation lamp 40 through the light shielding mask 60 to the radiation-curable resin 18 on the substrate 11.

The parts of this optical data recording medium manufacturing apparatus are described next.

The radiation lamp 40 may be any means of emitting radiation to cure the radiation-curable resin 18. The radiation lamp 40 could be round, for example. If the radiation lamp 40 is round, radiation can be emitted to all of the radiation-curable resin 18 on the substrate 11. The shape of the radiation lamp 40 is not limited to round, and can be a different shape. Because the radiation-curable resin 18 is cured while the substrate 11 is spinning, the radiation-curable resin 18 can preferably be cured in the shortest possible time. If a UV lamp is used as the radiation lamp 40, for example, the radiation-curable resin 18 can be cured to the degree that the radiation-curable resin 18 will not spread when spun at approximately 1200 rpm by one pulse of UV light. A pulsed UV-light system (RC-747, Xenon Corporation, for example) can be used as the radiation lamp 40. This UV light system can emit UV light pulses lasting several ten milliseconds per pulse. Note that radiation as used herein includes all types of electromagnetic radiation that can cure the radiation-curable resin 18, including infrared, visible light, UV light, and X-ray.

The light shielding mask 60 is described with reference to FIGS. 2A and 2B. FIG. 2A is a plan view showing the relative positions of the light shielding mask 60 and substrate 11, and FIG. 2B is a schematic section view of FIG. 2A.

The light shielding mask 60 has a circular hole with an inside diameter equal to or less than the outside diameter of the substrate 11 surrounded by a donut-shaped shield portion.

The light shielding mask 60 is positioned concentrically to the substrate 11 when seen from the radiation lamp 40 side, and shields only the outside edge part of the substrate 11 from radiation. The inside diameter of this donut-shaped light shielding mask 60 is 118 mm in this embodiment of the invention. Because the radiation-curable resin 18 on the substrate 11 is irradiated through this light shielding mask 60, the outside edge part of the substrate 11 is not exposed to the radiation. As a result, the radiation-curable resin 18 that is to be spun off from the outside edge part of the substrate 11 by rotating the substrate is not exposed to radiation-curable resin 18 and is therefore not cured, and can thus be spun off. Furthermore, the uncured resin 18 that is spun off the substrate 11 is shielded from the radiation by the light shielding mask 60, and the excess uncured resin can be recovered and recycled.

While the light shielding mask 60 is preferably disposed close to the substrate 11, variation in the thickness of the resin layer will be increased if the light shielding mask 60 contacts the uncured resin 18. The light shielding mask 60 is therefore preferably separated a predetermined distance from the substrate 11 to prevent contact with the uncured resin 18 on the substrate 11. The minimum distance between the light shielding mask 60 and substrate 11 is preferably approximately 500 μm, for example.

The light shielding mask 60 can be anything that can shield the radiation-curable resin from the radiation. More specifically, the light shielding mask 60 can be metal. Even more specifically, the light shielding mask 60 can be manufactured from a primarily aluminum alloy. Stainless steel can also be used. If reflection of the radiation 15 from the light shielding mask 60 has adverse effects, the surface of the light shielding mask 60 may be coated or colored.

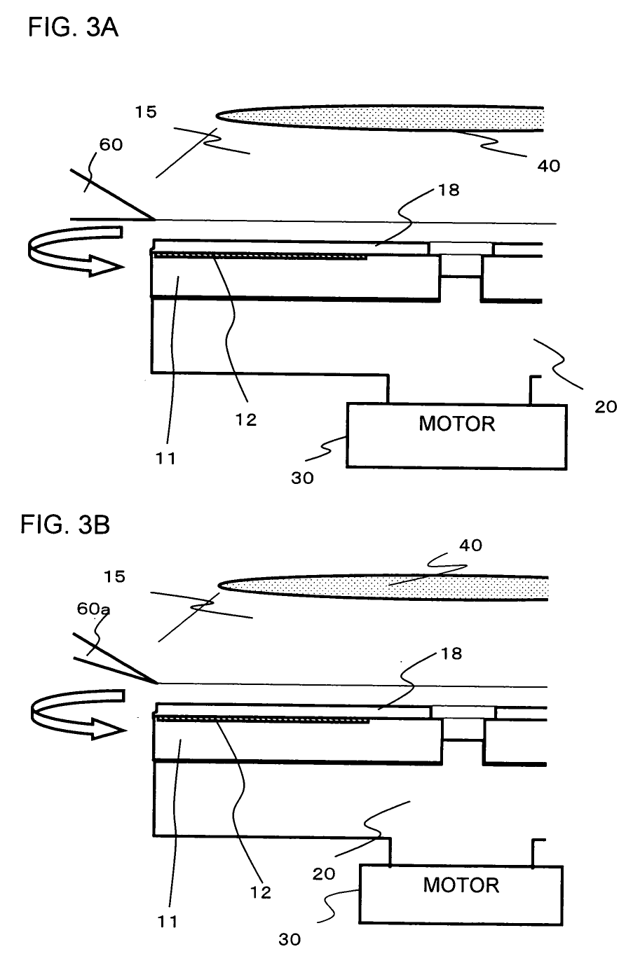

When seen in section, the light shielding mask 60 can be a light shielding mask 60 of which the bottom surface is parallel to the substrate 11 as shown in FIG. 3A, or a light shielding mask 60a of which the outside edge gradually angles away from the substrate 11 as shown in FIG. 3B. The light shielding mask 60 is preferably shaped so that the outside edge part of the substrate 11 is sufficiently shielded from radiation, and the uncured resin 18 that is spun off the substrate does not adhere to the light shielding mask 60.

This light shielding mask 60 is not necessarily an element of the optical data recording medium manufacturing apparatus. This light shielding mask 60 is used to prevent the radiation-curable resin 18 at the outside edge part of the substrate 11 from being exposed to radiation 15. Therefore, if a linear light source is used as the radiation lamp 40, for example, and is rendered to emit radiation 15 only to the radiation-curable resin 18 on the substrate 11 without exposing the radiation-curable resin 18 at the outside edge part of the substrate 11, the light shielding mask 60 can be omitted.

The control unit 50 can be achieved using a computer as the hardware component that runs a computer program. This control unit 50 controls the speed of the motor 30 and the radiation emission timing of the radiation lamp 40. For example, the control unit 50 can increase the speed of the motor 30, that is the rotational speed of the substrate 11, to a first rotational velocity, then slow the motor 30, and drive the radiation lamp 40 to emit radiation 15 to the radiation-curable resin 18 on the substrate 11 while the speed is slowing. Alternatively, the control unit 50 can increase the speed of the motor 30 to a first speed, then slow the motor 30 and emit the radiation 15 after the motor 30 reaches a second speed that is slower than the first speed.

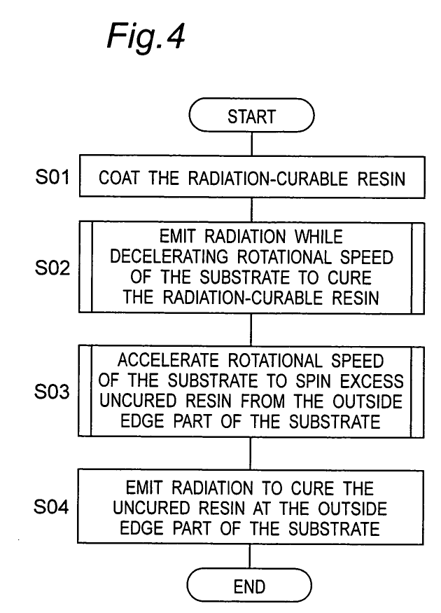

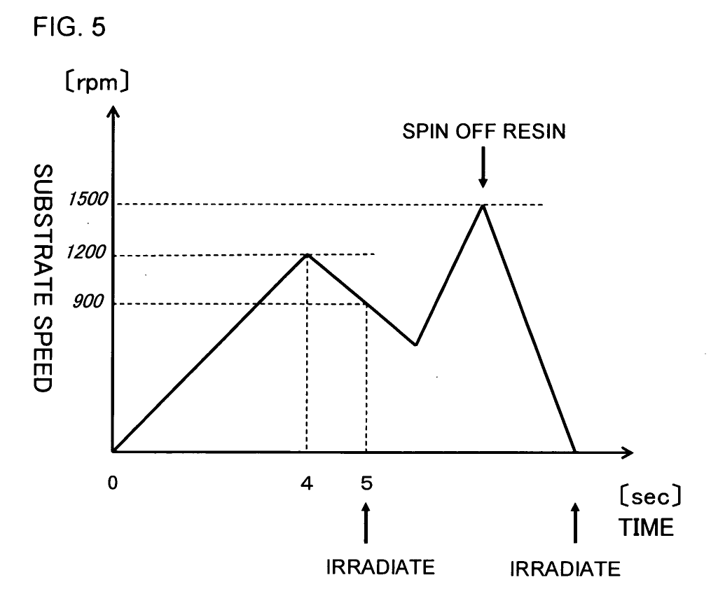

An optical data recording medium manufacturing method according to this first embodiment of the invention is described next with reference to the flow chart in FIG. 4 and the timing chart in FIG. 5. FIG. 4 is a flow chart of an optical data recording medium manufacturing method according to a first embodiment of the invention. FIG. 5 is a timing chart showing the relationship between substrate 11 speed and time in the optical data recording medium manufacturing method according to the first embodiment of the invention.

(1) The substrate 11 is first coated with radiation-curable resin 18 (SO1). For example, the substrate 11 can be coated using a spin coating method in which the substrate 11 is spun while the radiation-curable resin 18 is dripped onto the spinning substrate 11 to spread the radiation-curable resin 18 and coat the substrate 11. (2) The rotational speed of the substrate 11 is then increased to a predetermined speed (such as 1200 rpm in FIG. 5), and then decreased. While the rotational speed of the substrate 11 is slowing (to 900 rpm, for example), the radiation lamp 40 emits radiation 15 to the radiation-curable resin 18 on the substrate 11 through the light shielding mask 60 to cure the radiation-curable resin 18 (S02). Referring to the timing chart in FIG. 5, for example, the rotational speed of the substrate 11 reaches 1200 rpm four seconds after acceleration starts, then decelerates, and the radiation 15 is emitted when the rotational speed of the substrate 11 reaches 900 rpm after one second of deceleration. This is also known as “spin curing.”

(3) The rotational speed of the substrate 11 is then accelerated again to throw any excess uncured resin 18 off from the outside edge part of the substrate (S03). In the example shown in FIG. 5, the rotational speed of the substrate 11 is accelerated to 1500 rpm to throw off the uncured resin 18.

(4) The light shielding mask 60 is then removed and the uncured resin 18 at the outside edge part is irradiated with radiation 15 (at 0 rpm in FIG. 5) to cure the uncured resin 18 (final curing) (S04).

An optical data recording medium can be manufactured by the above procedure.

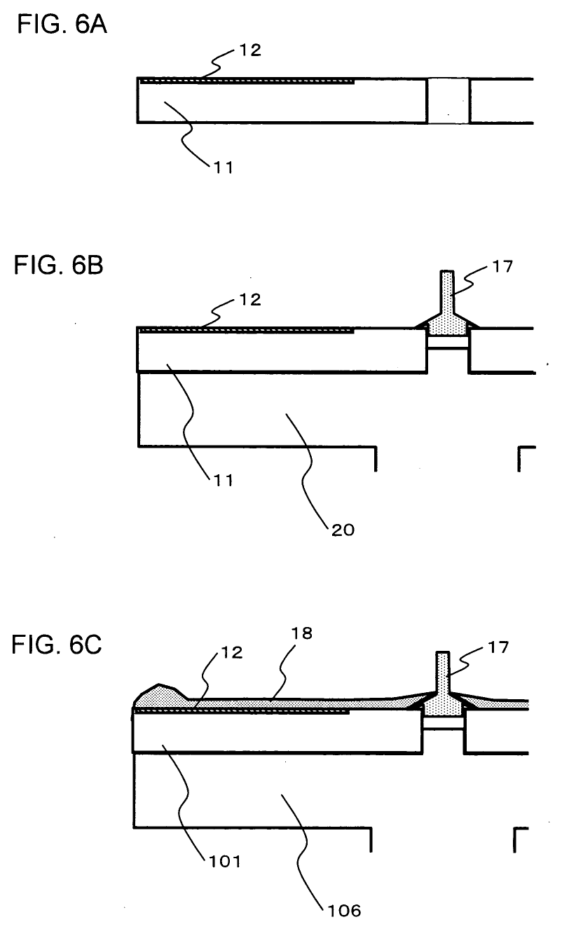

The step S01 of coating the substrate 11 with radiation-curable resin 18 is described next with reference to FIGS. 6A to 6C.

(a) A substrate 11 with a signal recording layer 12 is first prepared. A substrate that is approximately 1.1 mm thick and 120 mm diameter with an approximately 15 mm diameter center hole as shown in FIG. 6A can be used as the substrate 11. This substrate 11 can be manufactured by injection molding from polycarbonate. The substrate 11 could alternatively be manufactured from acrylic, polyolefin, or other resin material instead of polycarbonate. The signal recording layer 12 is a thin film of a silver alloy, aluminum alloy, or other material that is approximately 40 nm thick over the pits formed in the substrate 11.

(b) The substrate 11 is then set on the rotating table 20, and the center hole in the substrate 11 is covered with a cap 17 as shown in FIG. 6B.

(c) About 2 g of radiation-curable resin 18 with a viscosity of approximately 2000 mpa*s is then dripped onto the cap 17, and the rotational speed of the substrate 11 is spun at approximately 3300 rpm for approximately 1.5 seconds to spread the resin.

(d) The substrate 11 is then stopped, and the cap 17 is removed after coating (also called spin coating) the radiation-curable resin 18 is completed.

This procedure can be used for the step of coating the substrate 11 with the radiation-curable resin 18. When the radiation-curable resin 18 is applied in this way, the surface tension of the radiation-curable resin 18 can leave a ridge of resin 18 near the outside edge part of the substrate 11 as shown in FIG. 6C when the substrate 11 stops spinning after spreading the radiation-curable resin 18 is completed.

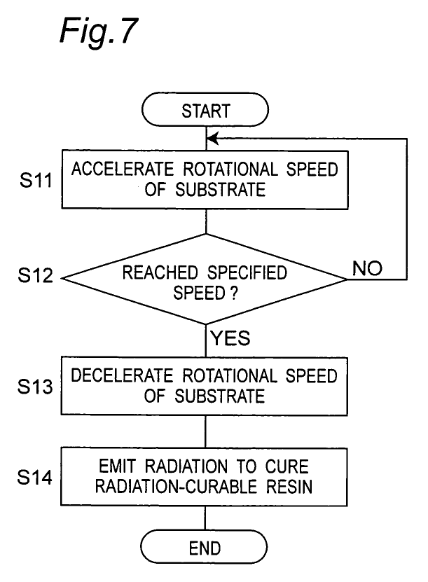

Step S02 in which the radiation-curable resin is cured by exposure to radiation while the rotational speed of the substrate is decelerating after the rotational speed of the substrate 11 is accelerated to the predetermined speed and is then decelerated is described next with reference to the flow chart in FIG. 7.

(a) The rotational speed of the substrate 11 is first increased (S11).

(b) Whether the rotational speed of the substrate 11 has reached the predetermined speed is then determined (S12). If the rotational speed of the substrate 11 has reached the predetermined speed, control goes to step S13. If the substrate 11 has not reached the predetermined speed, the procedure loops back to S11.

(c) If the rotational speed of the substrate 11 has reached the predetermined speed, the speed is reduced (S13). By accelerating the rotational speed of the substrate 11 to this predetermined speed, the build up of resin 18 near the outside edge part of the substrate can be suppressed.

(d) While the substrate 11 is decelerating, radiation 15 is emitted from the radiation lamp 40 to the radiation-curable resin 18 on the substrate 11 through the light shielding mask 60 to cure the radiation-curable resin 18 (S14). Sharp burrs can occur on the outside edge part when the radiation is emitted while the rotational speed of the substrate 11 is accelerated as in the method of the prior art. This is attributed to the emission of radiation curing the radiation-curable resin 18 at the outside edge part of the substrate 11 while trying to spin the resin off by increasing the rotational speed of the substrate 11. In the manufacturing method of an optical data recording medium according to the present invention, the radiation-curable resin 18 is cured by emitting radiation while the rotational speed of the substrate 11 is decreasing, however, and burrs are thus prevented because spinning the radiation-curable resin 18 off the substrate is suppressed by the substrate deceleration. Furthermore, with the optical data recording medium manufacturing method of the invention, radiation 15 is emitted to the radiation-curable resin 18 on the substrate 11 through the light shielding mask 60, and the light shielding mask 60 shields the outside edge part of the substrate 11 from the radiation. The radiation-curable resin 18 being spun off from the edge of the substrate 11 is therefore not cured and can be spun off the disc, and burrs can therefore be prevented.

The step S02 of emitting radiation to cure the radiation-curable resin 18 while the substrate 11 is decelerating can be completed by this procedure.

A light shielding mask 60 is used in the procedure described above, but a light shielding mask 60 is not necessarily required by the optical data recording medium manufacturing method of this invention. If a linear light source is used as the radiation lamp 40, for example, and is rendered to emit radiation 15 only to the radiation-curable resin 18 on the substrate 11 without exposing the radiation-curable resin 18 at the outside edge part of the substrate 11, the light shielding mask 60 can be omitted.

Furthermore, because the radiation-curable resin 18 that is spun off the substrate 11 is not exposed to radiation 15 when a light shielding mask 60 is used, the method of the invention affords the further benefit of enabling the excess radiation-curable resin 18 to be recovered and recycled.

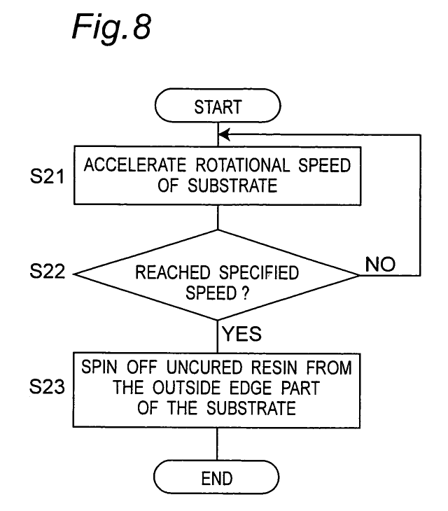

Step S03 of spinning excess radiation-curable resin 18 from the outside edge part of the substrate 11 is described next with reference to the flow chart in FIG. 8.

(a) The rotational speed of the substrate 11 is again accelerated (S21).

(b) Whether the rotational speed of the substrate 11 has reached the predetermined speed is determined (S22). If the rotational speed of the substrate 11 has not reached the specified speed, the procedure loops back to S21 and the rotational speed of the substrate 11 is accelerated. If the rotational speed of the substrate has reached the specified speed, control goes to step S23. This predetermined speed is preferably greater than the speed used for coating the resin and irradiation, and is preferably 1,500 rpm to 10,000 rpm, and further preferably 2,000 rpm to 9,000 rpm.

(c) If the rotational speed of the substrate 11 has reached the specified speed, excess radiation-curable resin 18 at the outside edge part of the substrate 11 can be spun off (S23).

This procedure can be used to complete the step S03 of spinning off excess radiation-curable resin 18 from the outside edge part of the substrate 11.

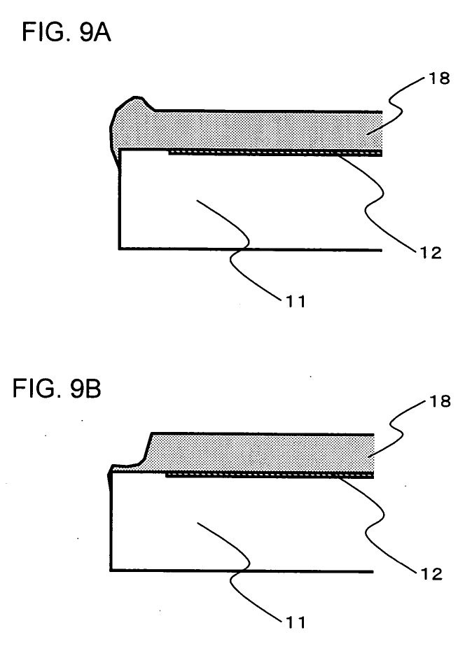

This process of spinning off excess resin is further described below. The step of curing the radiation-curable resin 18 by emitting radiation while the rotational speed of the substrate 11 decelerates can remove the part corresponding to the ridge of radiation-curable resin 18 shown in FIG. 6C, but excess uncured radiation-curable resin 18 may be left overhanging as shown in FIG. 9A near the outside edge part of the substrate 11 that was not exposed to radiation due to the light shielding mask 60. This overhanging ridge of resin may be as much as 50 μm. If this ridge is left and a load is applied to this part when handling the optical data recording medium, there is a danger of the light transmitting layer being removed. The rotational speed of the substrate 11 is therefore accelerated again in the spinning process of step S03 to spin off any excess uncured radiation-curable resin 18 due to high speed rotation. This spinning step enables forming a light transmitting layer of uniform thickness to near the outside edge part of the substrate 11, and enables providing a highly reliable optical data recording medium.

Depending on the amount of resin that is spun off, the light transmitting layer may have a step near the outside edge part of the substrate 11. It is also preferable that after this spinning step the radiation-curable resin 18 is not completely removed near the outside edge part of the substrate 11. Furthermore, because disc strength drops if the thickness of the light transmitting layer is too thin, the thickness of the light transmitting layer near the outside edge part of the disc is preferably 3 μm or more, and further preferably is greater than or equal to 10 μm and less than or equal to 90 μm. This step near the outside edge part can be, for example, 10 μm or more. There is also the danger of corrosion due to oxidation if the reflective layer formed on the signal recording layer is exposed to air. This step is therefore preferably to the outside of the signal recording area specifically at a radius of 58.6 mm or more and further preferably 59.0 mm or more. Yet further preferably, the signal recording layer 12 is covered by a slight thickness of resin 18 even after the resin 18 is spun off.

The step S04 of removing the light shielding mask 60 and emitting radiation 15 to cure the uncured radiation-curable resin 18 at the outside edge part of the substrate 11 is described next.

As described above, after the rotational speed of the substrate 11 is accelerated and excess uncured resin near the outside edge part of the substrate is removed, it is necessary to cure the uncured radiation-curable resin 18 that was under the light shielding mask 60 and near the outside edge part of the substrate 11. To do this, the light shielding mask 60 is removed, and radiation 15 is emitted to the outside edge part of the substrate 11 to cure the uncured radiation-curable resin (final curing step). In the timing chart shown in FIG. 5, radiation is emitted for the final curing after the rotational speed of the substrate goes to 0 rpm. Note that the timing for emitting radiation for this final curing is not limited to this example.

This procedure can be executed as the step S04 of emitting radiation to the uncured radiation-curable resin 18 at the outside edge part of the substrate 11.

The optical data recording medium manufacturing method of the present invention can be completed by these steps S01 to S04. The step S01 of coating the substrate 11 with radiation-curable resin 18 and the step S02 of emitting radiation to cure the radiation-curable resin while the rotational speed of the substrate 11 decelerates are essential to the optical data recording medium manufacturing method of the invention, but the step S03 of spinning excess uncured resin 18 off the substrate 11 is not essential.

More specifically, the step S03 of spinning off excess resin is not necessary if the resin 18 can be sufficiently spun off by the first acceleration in the step S02 of emitting radiation to cure the radiation-curable resin 18 while the rotational speed of the substrate 11 decelerates. In this case the step S04 of irradiating the uncured resin 18 near the outside edge part of the substrate 11 to cure the uncured resin 18 is also not necessary.

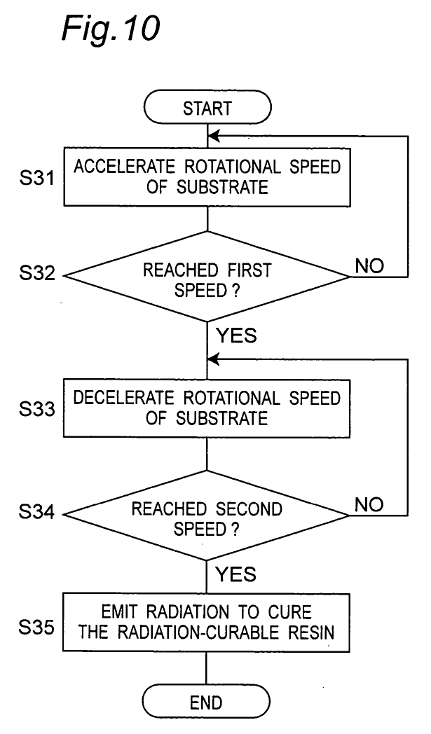

Another example of an optical data recording medium manufacturing method according to the present invention is described next with reference to the flow chart in FIG. 10. This optical data recording medium manufacturing method differs in the step S02 shown in FIG. 4 of curing the radiation-curable resin by exposure to radiation while the rotational speed of the substrate 11 decelerates as described in FIG. 7. More specifically, this method emits radiation after the substrate 11 slows from a first speed to a second speed.

(a) The rotational speed of the substrate 11 is first increased (S31).

(b) Whether the rotational speed of the substrate 11 has reached a first speed is determined (S32). If the rotational speed of the substrate 11 has reached the first speed, control goes to step S33. If the rotational speed of the substrate 11 has not reached the first speed, the procedure returns to step S31.

(c) If the rotational speed of the substrate 11 has reached the first speed, the speed is reduced (S33). By accelerating the rotational speed of the substrate 11 to this first speed, the build up of resin 18 near the outside edge part of the substrate can be suppressed.

(d) Whether the rotational speed of the substrate 11 has slowed to a second speed is determined (S34). If the rotational speed of the substrate 11 has slowed to the second speed, control goes to step S35. If the rotational speed of the substrate 11 has not slowed to the second speed, the procedure returns to step S33. It is noted that feedback control can be performed with respect to the rotational speed of the substrate 11 when the speed does not reach the second speed at the step S34. Then, the rotational speed of the substrate 11 may quickly reach the second speed.

(e) After the rotational speed of the substrate 11 slows to the second speed, radiation 15 is emitted from the radiation lamp 40 to the radiation-curable resin 18 on the substrate 11 through the light shielding mask 60 to cure the radiation-curable resin 18 (S35).

The step S02 of emitting radiation to cure the radiation-curable resin 18 after the rotational speed of the substrate 11 slows from a first speed to a second speed can be completed by this procedure.

In this example of a manufacturing method for an optical data recording medium radiation is emitted to cure the radiation-curable resin 18 after the rotational speed of the substrate 11 slows from a first speed to a second speed. This first speed and second speed (irradiation timing), and thickness variation in the radiation-curable resin at the outside edge part of the substrate, are considered below.

The effect of using a light shielding mask is described first. If the radiation-curable resin 18 is cured while the substrate 11 is spinning when a light shielding mask 60 is used, air flows from the inside circumference side of the substrate 11 between the outside edge of the substrate 11 and the light shielding mask 60 to the outside. The flow of air also increases where the gap is small between the light shielding mask 60 and the outside of the substrate 11, and the strength of this air flow tends to thin the uncured resin 18 near the outside edge part of the substrate 11.

What happens when radiation is emitted while the rotational speed of the substrate 11 is accelerated as in the prior art is described next.

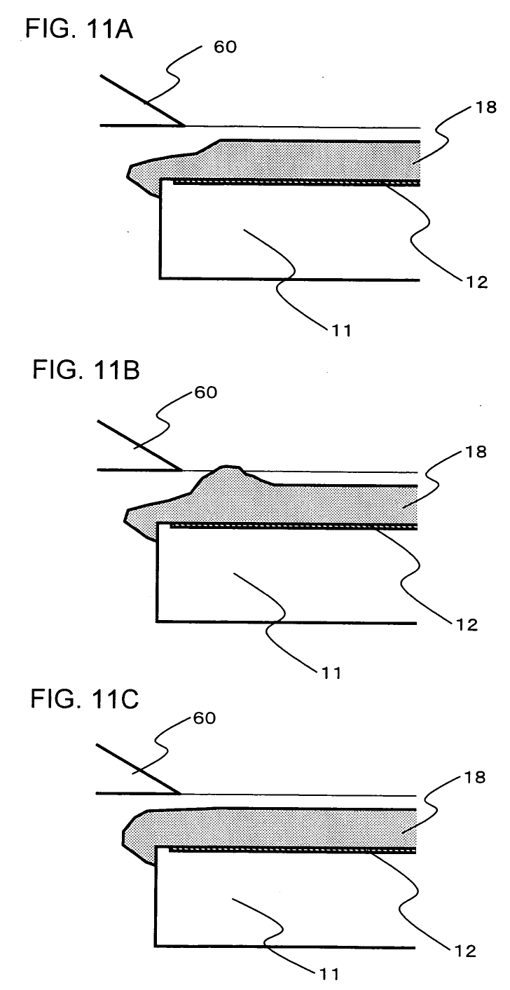

When the timing at which radiation is emitted while the rotational speed of the substrate is increasing is gradually changed and a light shielding mask 60 is not used, burrs occur at the outside edge part of the substrate as described above. When a light shielding mask 60 is used, however, the addition of the light shielding mask 60 adds the force of air flow to the centrifugal force of substrate 11 rotation, producing excessive force pushing the radiation-curable resin 18 to the outside of the substrate and resulting possibly in the radiation-curable resin 18 being coated as shown in FIG. 11A. The rate of acceleration and the rotational speed of the substrate were therefore reduced while adjusting the radiation timing during acceleration, but this tends to increase variation in the resin thickness. For example, when the rotational speed of the substrate was accelerated at 200 rpm/sec and UV light was emitted when the rotational speed of the substrate reached approximately 800 rpm, the thickness increased in the area near the light shielding mask as shown in FIG. 11B, but the build-up of resin in FIG. 11B near the outside edge part of the substrate is not completely removed immediately after coating.

The first speed and second speed of this alternative optical data recording medium manufacturing method of the invention in which radiation is emitted to the radiation-curable resin through the light shielding mask 60 after the rotational speed of the substrate decreases from the first speed to the second speed were therefore studied.

In the previous example the rotational speed of the substrate is firstly accelerated at 300 rpm/sec to 1200 rpm (the first speed), then decelerated at −300 rpm/sec, and radiation is emitted when the speed reaches 900 rpm/sec (the second speed). The resin at the outside edge part of the substrate appears as shown in FIG. 11C in this case. As will be known from the figures, the thickness variation shown in FIGS. 11A and 11B is eliminated, and an extremely uniform thickness is achieved. This is because the ridge of radiation-curable resin 18 at the outside edge part of the substrate 11 is removed by centrifugal force during acceleration to 1200 rpm (first speed) (as shown in FIG. 11A), and deceleration to 900 rpm (second speed) pulls some of the radiation-curable resin 18 below the light shielding mask 60 back toward the inside circumference of the substrate 11.

Rotational speed of the substrate when using the light shielding mask 60 was also studied. The rotational speed of the substrate was varied while still applying the basic principle of first accelerating, then decelerating, and then irradiating. In the previous example the rotational speed of the substrate rises to 1200 rpm in 4 seconds, then slows to 900 rpm in 1 second, and radiation is then emitted. We also studied, for example, accelerating to 1500 rpm in 4 seconds and then decelerating to 800 rpm. Because the absolute value of the thickness decreases depending on the combination of speeds, the thickness to which the resin is first coated was adjusted so that the absolute thickness was the same for each speed combination. It was shown that if the conditions yielding a thickness distribution of 4 μm or less, for example, at each of multiple combinations are found, the speed to which the rotational speed of the substrate is slowed (the second speed) has a greater effect on the thickness variation than the speed to which the rotational speed of the substrate is accelerated (the first speed). Because these speeds (first speed and second speed) will obviously vary according to the viscosity of the radiation-curable resin, the optimum range is preferably selected according to the viscosity. At a viscosity of 2000 mpa*s as in this embodiment of the invention, the rotational speed of the substrate when radiation is emitted (the second speed) is preferably greater than or equal to 400 rpm and less than or equal to 1000 rpm.

The time required to accelerate to the first speed is considered next. The results were the same as for the speed combinations described above. That is, if the time used for acceleration is too short (acceleration is too great), the force of acceleration increases, and there is tendency to spin off too much uncured resin at the outside edge part of the substrate. The thickness variation is therefore unacceptable. On the other hand, accelerating slowly has no effect on thickness variation. Because the absolute thickness is too low if the rotational speed of the substrate is too high, the thickness of the coated resin was adjusted so that the absolute thickness was the same for each combination.

Furthermore, if the time required to slow from the first speed to the second speed is too short, that is, deceleration is too fast, the effect of lowering the speed is difficult to achieve. Conversely, if the deceleration time is too great, that is, deceleration is too slow, the effect of the first acceleration is diminished. There is therefore an ideal range.

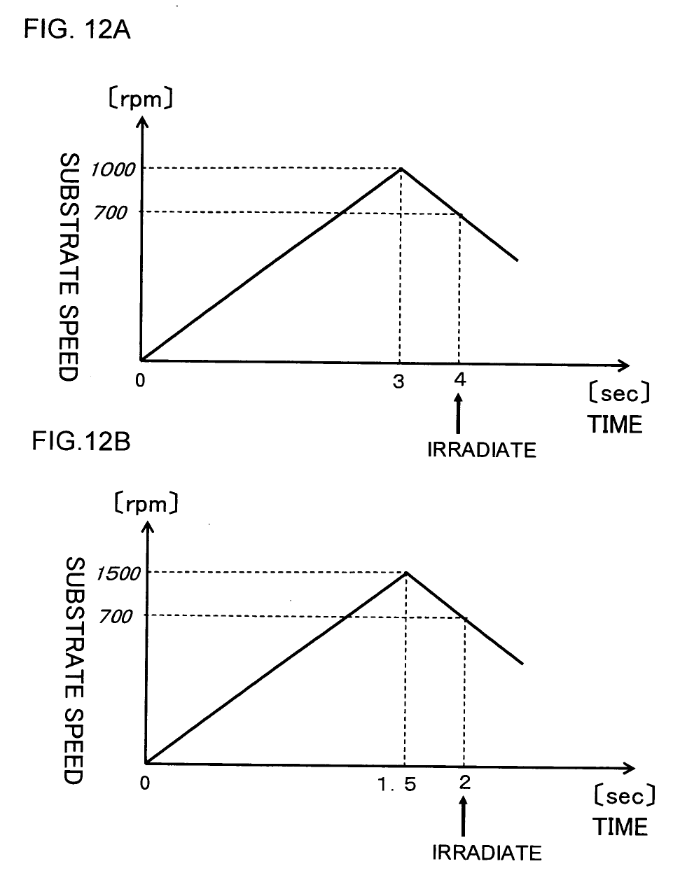

In this embodiment of the invention the deceleration time to the second speed (radiation time) after the maximum speed (first speed) is reached is preferably 0.3 second or greater and less than 2 seconds. When manufacturing optical data recording media, the shortest possible tact time affording consistent high quality is desirable. Combinations such as shown in FIGS. 12A and 12B, for example, enable production with a high yield. In the example shown in FIG. 12A, the first speed is 1000 rpm (after 3 seconds), and the second speed is 700 rpm (after accelerating for 4 seconds and then decelerating from the first speed for 1 second). In the example shown in FIG. 12B, the first speed is 1500 rpm (after 1.5 seconds), and the second speed is 700 rpm (after decelerating from the first speed for 0.5 second after the first 2 seconds).

In another example, the rotational speed of the substrate 11 is slowed to the second speed and radiation is emitted while holding the second speed (900 rpm in this example) for a predetermined time. There is a tendency to gradually lose the effect of achieving a uniform thickness as the time the constant speed is held after deceleration increases. Therefore, radiation 15 can be emitted to cure the radiation-curable resin 18 while holding a constant speed after slowing the rotational speed of the substrate 11, but the radiation 15 is preferably emitted to cure the radiation-curable resin 18 while the substrate 11 is decelerating.

A radiation-curable resin 18 with a viscosity of 2000 mpa*s is used in this embodiment of the invention, but the viscosity of the radiation-curable resin 18 is not so limited and can be suitably adjusted according to the desired thickness of the light transmitting layer and the size of the grooves or pits and lands in the recording film. The speed used for spin coating, spin curing, and spinning off excess resin can also be set suitably according to the viscosity of the radiation-curable resin 18. If the resin 18 viscosity is high, the speed can be set from several hundred rpm to about 10,000 rpm. If radiation-curable resins 18 of different viscosity are used, the optimum speed and spin time can be suitably set according to the viscosity of each resin.

The light transmitting layer is preferably substantially transparent to the wavelength of the laser used for reading and writing. The optical data recording medium in this embodiment of the invention reads and writes using an approximately 405 nm laser, and transmittance at this wavelength is 90% or higher.

A read-only optical data recording medium including a reflective layer of aluminum or silver alloy and a light transmitting layer built over a substrate containing pits is used by way of example above, but the invention is not so limited. The optical data recording medium manufacturing method of the present invention can also be applied to rewritable read/write media having a phase-change recording thin film and light transmitting layer formed on a substrate containing pits or grooves, as well as section-writable write-once optical data recording media.

Second Embodiment

An optical data recording medium manufacturing method according to a second embodiment of the invention is described next.

The optical data recording medium manufacturing method of this embodiment differs from the manufacturing method of the first embodiment in that a protective layer instead of a light transmitting layer is formed from a radiation-curable resin. Further description of like parts in this and the first embodiment is omitted.

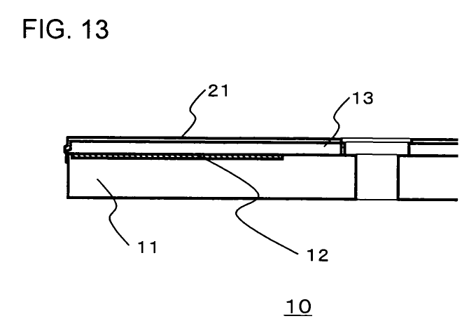

When the light transmitting layer is formed from a radiation-curable resin as in the optical data recording medium manufactured by the first embodiment of the invention, the hardness of the cured resin after curing can be designed to a pencil hardness of approximately “HB” or “B” in order to reduce warping the optical data recording medium due to shrinkage when curing the radiation-curable resin. However, the light transmitting layer may be too soft in this case, resulting in scratches on the light transmitting layer surface from handling the optical data recording medium and an adverse effect on read/write performance. As shown in FIG. 13, therefore, a protective layer 21 is preferably formed over the light transmitting layer 13. The hardness of this protective layer 21 is preferably a pencil hardness of “H” or higher in order to prevent scratching. The protective layer 21 also preferably provides outstanding resistance to soiling from fingerprints, for example.

Pencil hardness as used herein can be determined by sharpening the tip of pencil, holding the tip at 45 degrees to surface while applying a 1 kg load and pulling the tip over the surface to determine if scratches are left. Measuring pencil hardness is done in accordance with the Japanese Industrial Standards No. JIS-K5400.

In the optical data recording medium manufacturing method of this second embodiment of the invention, the protective layer 21 can be manufactured from a radiation-curable resin in the same way as the light transmitting layer is made from a radiation-curable resin in the optical data recording medium manufacturing method of the first embodiment described above.

Third Embodiment

An optical data recording medium manufacturing method according to a third embodiment of the invention is described next.

The optical data recording medium manufacturing method of this embodiment differs from the manufacturing method of the first embodiment in that a multiple layer optical data recording medium having a plurality of signal recording layers is manufactured. More particularly, intermediate layers are formed between the plural signal recording layers in the same way as the light transmitting layer is formed from radiation-curable resin in the optical data recording medium manufacturing method of the first embodiment. Further description of like parts in this and the first and second embodiments is omitted.

The invention has been described in the previous embodiments using by way of example a single layer optical data recording medium having only one signal recording layer, but the optical data recording medium manufacturing method of the invention can also be used for multiple layer optical data recording media having two or more signal recording layers.

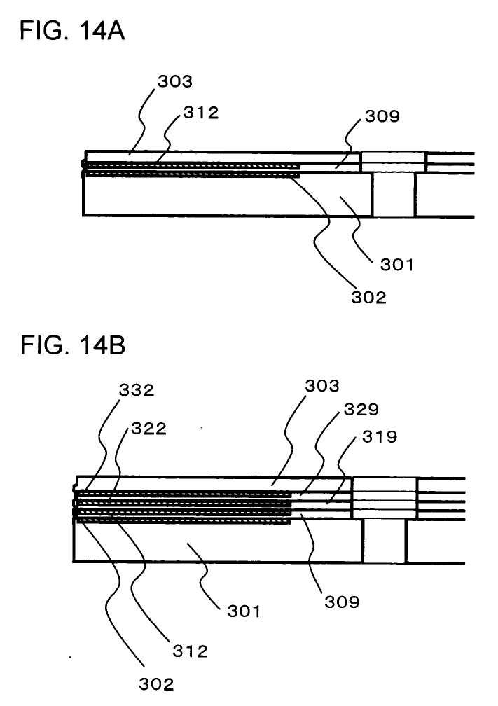

FIG. 14A is a section view of an optical data recording medium with two signal recording layers. This two-layer optical data recording medium has an approximately 25 μm thick intermediate layer 309 between signal recording layer 302 and signal recording layer 312, and an approximately 75 μm thick light transmitting layer 303.

FIG. 14B is a section view of an optical data recording medium with four signal recording layers. This four-layer optical data recording medium has an approximately 15 μm thick intermediate layer 309, 319, 329 between signal recording layers 302, 312, 322, and 332, and an approximately 55 μm thick light transmitting layer 303.

In both this two-layer optical data recording medium and four-layer optical data recording medium, the light transmitting layer 303 and the intermediate layers 309, 319, 329 are manufactured using the same method as in the first embodiment of the invention.

This optical data recording medium manufacturing method is described more specifically below.

(a) A radiation-curable resin 308 is first coated over the signal recording layer 302 on the substrate 301. A radiation-curable resin with approximately 2000 mPa*s viscosity is used and spin coated for approximately 3 seconds at approximately 2000 rpm using a cap 17 as described in the first embodiment of the invention.

(b) The rotational speed of the substrate 301 is then accelerated to a predetermined speed, then decelerated, and at least a part of the radiation-curable resin is cured by emitting radiation through a light shielding mask 60 during deceleration. A light shielding mask 60 having a 118 mm diameter center hole is used, for example. The rotational speed of the substrate 301 is then increased to 600 rpm at 150 rpm/sec, the rotational speed of the substrate 301 is then slowed at −150 rpm/sec to 400 rpm, and radiation is emitted when the speed reaches 400 rpm. A pulsed UV-light system (RC-747, Xenon Corporation, for example) can be used as the radiation lamp 40. This UV light system can emit UV light pulses lasting several ten milliseconds per pulse. Because signals will be printed in the radiation-curable resin, the radiation-curable resin is not completely cured at this time and the surface must be left in an uncured state. The surface can be left uncured by, for example, lowering the strength of the radiation, but if this leaves the surface too hard, the cured hardness can be adjusted by changing the radiation environment. Curing the radiation-curable resin used in this embodiment of the invention can be impeded by using a super-oxygenated atmosphere, and a stable uncured resin state can be achieved by increasing the oxygen concentration of the atmosphere.

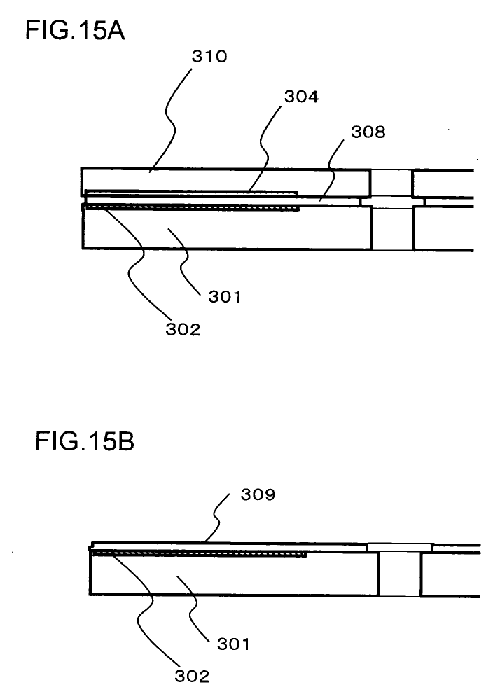

(c) A stamper 310 containing the grooves or pits and land formation to be formed is then pressed into the uncured surface of the radiation-curable resin as shown in FIG. 15A. A roller can be used to press the stamper 310 to the substrate 301 from one edge, for example. If air bubbles tend to become trapped between the stamper 310 and substrate 301, the stamping step can be done in a vacuum.

(d) Radiation is then emitted while the stamper 310 is pressed to the substrate 301 to completely cure the radiation-curable resin 308.

(e) After completely curing the radiation-curable resin 308, the stamper 310 is removed, and an approximately 25 μm thick intermediate layer 309 can be formed as shown in FIG. 15B. The stamper 310 can be a polyolefin substrate that is transparent to the radiation, for example. Note that if the substrate 301 and the signal recording layer 302 preformed on the substrate 301 are transparent to the radiation, the stamper 310 does not need to be transparent. A metal stamper could be used, for example.

(f) After removing the stamper 310, a metallic film is formed over the resulting grooves or lands and pits to form a signal recording layer.

(g) Steps (a) to (f) are then repeated to form the light transmitting layer 303 and complete a multiple layer optical data recording medium.

The coating conditions and viscosity of the radiation-curable resin can be changed according to the thickness of the produced light transmitting layer and intermediate layer. This embodiment irradiates the radiation-curable resin coating to partially cure the radiation-curable resin before applying the stamper. and then emitting radiation once again to completely cure the resin, but the invention is not so limited. The stamper could be applied to the coated radiation-curable resin before irradiating the resin, and radiation could be emitted to cure the radiation-curable resin after stamping.

As in the optical data recording medium manufacturing method according to the second embodiment above, a protective layer made from a radiation-curable resin can also be formed in this optical data recording medium manufacturing method. The multiple layer optical data recording medium may also be a rewritable read/write medium, a section-writable write-once medium, or a read-only medium having a reflective layer of primarily aluminum or silver. The optical data recording medium manufacturing method and optical data recording medium according to the present invention can be used to manufacture an optical data recording medium having a light transmitting layer, intermediate layer, or protective layer made from a radiation-curable resin.

Although the present invention has been described in connection with the preferred embodiments thereof with reference to the accompanying drawings, it is to be noted that various changes and modifications are apparent to those skilled in the art. Such changes and modifications are to be understood as included within the scope of the present invention as defined by the appended claims, unless they depart therefrom.

What is claimed is:

1. A manufacturing method for an optical data recording medium having a substrate with at least one signal recording layer and a resin layer for passing light, the method comprising:
coating a radiation-curable resin on the substrate; and
forming the resin layer by curing at least a part of the radiation-curable resin by increasing the rotational speed of the substrate to a first speed, then decreasing the rotational speed of the substrate, and emitting radiation while the rotational speed of the substrate is decreasing.

2. The optical data recording medium manufacturing method according to claim 1, wherein the step of forming the resin layer forms the resin layer by curing at least a part of the radiation-curable resin by emitting radiation after the rotational speed of the substrate reaches a second speed that is lower than the first speed.

3. The optical data recording medium manufacturing method according to claim 2, wherein the step of forming the resin layer forms the resin layer by curing at least a part of the radiation-curable resin by emitting radiation while rotating the substrate at the second speed for a predetermined time.

4. The optical data recording medium manufacturing method according to claim 1, wherein the step of forming the resin layer forms the resin layer by curing at least a part of the radiation-curable resin by emitting radiation to the substrate through a light shielding mask,
the light shielding mask having a round hole with an inside diameter equal to or less than the outside diameter of the substrate, and disposed with this hole in the light shielding mask concentric to the substrate.

5. The optical data recording medium manufacturing method according to claim 4, further comprising:
spinning off radiation-curable resin at the outside edge part of the substrate after the step of forming the resin layer by accelerating the rotational speed of the substrate to a predetermined speed that is higher than the first speed.

6. The optical data recording medium manufacturing method according to claim 5, further comprising:
emitting radiation to the outside edge part of the substrate to cure the radiation-curable resin at the outside edge part of the substrate after the step of spinning off the radiation-curable resin at the outside edge part of the substrate.

7. The optical data recording medium manufacturing method according to claim 1, wherein the step of coating the radiation-curable resin uses a spin coating method.

8. The optical data recording medium manufacturing method according to claim 1, wherein the step of coating the radiation-curable resin uses a substrate with a center hole, and covers the center hole to coat the radiation-curable resin on the substrate.

9. The optical data recording medium manufacturing method according to claim 1, wherein the resin layer is a light transmitting layer rendered on top of a signal recording layer.

10. The optical data recording medium manufacturing method according to claim 1, wherein the resin layer is a protective layer.

11. The optical data recording medium manufacturing method according to claim 1, wherein the resin layer is an intermediate layer rendered between a plurality of signal recording layers.

12. The optical data recording medium manufacturing method according to claim 11, further comprising:
forming an intermediate layer by applying a stamper having a pattern of grooves or pits and lands to the at least partly cured radiation-curable resin on the substrate, and then emitting radiation to cure the uncured resin after the step of forming the resin layer.

13. A manufacturing apparatus for an optical data recording medium, comprising:
a rotating table operable to rotatably hold a substrate coated with a radiation-curable resin;
a motor operable to rotate the rotating table;
a radiation lamp operable to emit radiation to the radiation-curable resin on the substrate to cure at least a part of the radiation-curable resin; and
a control unit operable to control the speed of the motor and the emission timing of the radiation lamp.

14. The optical data recording medium manufacturing apparatus according to claim 13, further comprising:
a light shielding mask having a round hole with an inside diameter equal to or less than the outside diameter of the substrate, the light shielding mask disposed between the substrate and the radiation lamp without contacting the substrate and with the hole in the light shielding mask concentric to the substrate as seen from the radiation lamp;
wherein radiation is emitted from the radiation lamp through the light shielding mask to the substrate.

15. The optical data recording medium manufacturing apparatus according to claim 13, wherein:
the control unit increases the speed of the motor to a first speed, then decreases the speed, and emits radiation from the radiation lamp to the radiation-curable resin on the substrate while the speed is decreasing.

16. The optical data recording medium manufacturing apparatus according to claim 13, wherein:
the control unit increases the speed of the motor to a first speed, then decreases the speed, and after the motor reaches a second speed that is lower than the first speed emits radiation from the radiation lamp.

17. An optical data recording medium manufactured by the manufacturing method according to claim 1, wherein:
the resin layer thickness near the outside edge part of the substrate is 10 μm or more thinner than the average thickness of the entire resin layer on the substrate.
